(19) United States
(12) Patent Application Publication
(10) Pub. No.: US 2007/0218449 A1
(43) Pub. Date: Sep. 20, 2007

(54) Method and system for teaching writing

(76) Inventors: Deborah Reck, Lexington, MA (US); Arthur Unobskey, Lexington, MA (US); Deborah Sabin, Lexington, MA (US); David Meyers, Jamaica Plain, MA (US)

Correspondence Address: Mark S. Leonardo;Brown Rudnick Berlack Israels LLP, BOX IP, One Financial Center, Boston, MA, 02111, US

(21) Appl. No.: 11/712,154

(22) Filed: Feb. 28, 2007

Related U.S. Application Data
(60) Provisional application No. 60/777,289, filed on Feb. 28, 2006.

(51) Int. Cl. G09B 3/00

(52) U.S. Cl. 434/350

(57) ABSTRACT

A method of teaching writing is provided. The method includes the steps of instructing a student with a set of writing skills that is organized by skill sets, the skill sets being taught in a sequenced manner in order to teach writing ability to the student. The method also includes the sequence of skill sets addressing a set of prerequisite behavioral habits prior to addressing the students' writing skills. The method further includes the sequence of skill sets including the ability to develop a particular moment description, the ability to use evidence for the moment description, and the ability to use correct sentence mechanics in the moment description.

### RELATED APPLICATION INFORMATION

This patent application claims priority to U.S. Provisional Application No. 60/777,289, filed in the U.S. on Feb. 28, 2006.

### FIELD OF INVENTION

The present disclosure generally relates to methods of teaching and more particularly to a method and system of teaching writing that is organized by a sequence of discrete skills that incorporates a tracking tool and a system of predetermined feedback.

### BACKGROUND

Teaching writing can be frustrating for both teachers and students. Many students have difficulty learning to write and improving writing skills. Furthermore, many teachers become frustrated when students do not improve writing skills even after many hours of instruction.

Many methods of teaching writing are known. Most of these teaching methods are organized by parts of the writing process, genres or thematic subject matter. Unfortunately, these methods have not been successful, as many students continue to struggle with writing despite efforts by teachers to improve student writing.

Therefore, it would be desirable to provide a research-based method of writing instruction that enables teachers to lead students through the sequential development of their writing skills, track their ongoing progress, and provide feedback targeted to each student's needs.

### SUMMARY

Accordingly, a method of teaching writing is provided. The method includes the steps of instructing a student with a set of writing skills that is organized by skill sets, the skill sets being taught in a sequenced manner in order to steadily develop the student's writing ability. The method further includes the sequence of skill sets that develop a set of prerequisite behavioral habits prior to addressing the students' writing skills. Additionally, the method includes the sequence of skill sets including the ability to develop a particular moment description, the ability to use evidence for the moment description, and the ability to use correct sentence mechanics in the moment description.

In one embodiment, the skill sets include establishing habits and strengthening voice to teach students to express their own thoughts, feelings, and perceptions with clear and powerful sentences and paragraphs. In another embodiment strengthening voice includes expressive skills and technical skills.

In another embodiment, the skill sets further include building structure to teach students to write sentences and paragraphs to engage a reader. Building structure can include learning paragraph use and structure, creating dialogue and using evidence, developing setting and context, varying sentence style, varying voice, developing sentence structure, working on verb tense and learning subject verb agreement. Building structure can further include the skill minimizing cliché.

In yet another embodiment, the skill sets further include the skill of writing strategically. Writing strategically may include learning to use dialogue and evidence. Writing strategically may further include essay writing, developing setting and context and sustaining mood and tone.

In another embodiment, the behavioral habits include writing journal entries, practicing skill drills, engaging in experience, responding to feedback, developing vocabulary and sharing writing.

The skill sets can include focus, showing, strong verbs, sensory detail, dialogue and evidence, character development and distinguishing moments. Additionally, the moment description may include the development of a particular moment of narrative or analysis.

In another embodiment, the method includes the step of providing predetermined feedback.

A system for teaching writing is also included. The system includes an instructional component indicating a developmental sequence of discrete writing skills and an instructional component including a tracking tool located in proximity to a location of student work and teacher feedback. The tracking tool includes indicia for the student and teacher to access the student's progress with the developmental sequence of discrete skills. The tracking tool provides data regarding the student's progress through a developmental sequence of discrete skills so as to enable the teacher to customize instruction to each student individually, and to differentiate instruction for individual students, small groups of students, and whole classes of students.

In another embodiment the sequence of discrete writing skills includes establishing habits and strengthening voice. Additionally, the tracking tool includes a sticker, card, placemat and sign. In another embodiment, the tracking tool includes indicia for marking down when a student has accomplished a certain level of proficiency in a discrete skill. Also, the tracking tool can be located in proximity to a writing tablet, notebook or writing journal.

The tracking tool provides the teacher with tracking data for focusing the teacher feedback on identified areas of need in the student's development of discrete skills.

In accordance with the present disclosure, a system of instructional feedback on writing is provided. The system includes providing appreciative comments from a teacher to a student indicating the impact the student's writing has made on the teacher and providing instructive comments that direct the student to correct or improve or practice a specific discrete writing skill. The system further includes separating in time the step of providing appreciative comments to the student from the step of providing instructive comments to the student and requiring the student to complete a focused revision of the student's writing that implements the specific discrete writing skill.

In another embodiment, the system includes the step of providing appreciative comments, the appreciative comments include the teacher's response as a reader of the writing or the effect the student's writing had on the teacher.

A method for teaching writing skills is provided. The method includes providing a sequence of skills hierarchy for a student's development of a corresponding sequence of writing skills and instructing the student to perform a first task in said sequence. The method also includes providing predetermined feedback to the student which addresses specific deficiencies in the student's performance of the first task and repeating said instructing and providing until the student has reached a predetermined measurable achievement level in the first task. The method further includes that for each of the remaining tasks in the sequence, the steps included instruct the student to perform a next task in said sequence, providing predetermined feedback to the student which addresses specific deficiencies in the student's performance of said task and repeating said instructing and providing until the student has reached a predetermined measurable achievement level in the task before moving on to the next task in the sequence.

In another embodiment, the sequence of learning skills comprises a first stage consisting of establishing foundational habits; and a second stage consisting of strengthening voice.

In yet another embodiment, the method includes a third stage consisting of building structure; and a fourth stage consisting of writing strategically.

### BRIEF DESCRIPTIONS OF THE DRAWINGS

The objects and features of the present disclosure, which are believed to be novel, are set forth with particularity in the appended claims. The present disclosure, both as to its organization and manner of operation, together with further objectives and advantages, may be best understood by reference to the following description, taken in connection with the accompanying drawings wherein:

FIG. 1 is a flow chart illustrating an exemplary embodiment of the method in accordance with the present disclosure;

FIG. 2 is a flow chart illustrating step 1 of and exemplary embodiment of the method in accordance with the present disclosure;

FIG. 3 is a flow chart illustrating step 2 of and exemplary embodiment of the method in accordance with the present disclosure;

FIG. 4 is a flow chart illustrating step 3 of and exemplary embodiment of the method in accordance with the present disclosure; and

FIG. 5 is a flow chart illustrating step 4 of and exemplary embodiment of the method in accordance with the present disclosure.

### DETAILED DESCRIPTION OF EXEMPLARY EMBODIMENTS

The exemplary embodiments of the method and system of teaching writing are disclosed. It is contemplated that the methods will vary based on skill level and grade of students. Various modifications are required based on skill level, size of class, grade of students and other differences that would require changing the focus to specific skills. Not all of the stages will be required for younger students or students with a lower skill level.

Although the present invention is described herein generally in terms of a method for teaching writing skills, persons having ordinary skill in the art should understand that various embodiments of the disclosed method can be used for teaching any number of other subjects, such as, for example, physics, mathematics, foreign languages and workplace skills without departing from the scope of the present invention.

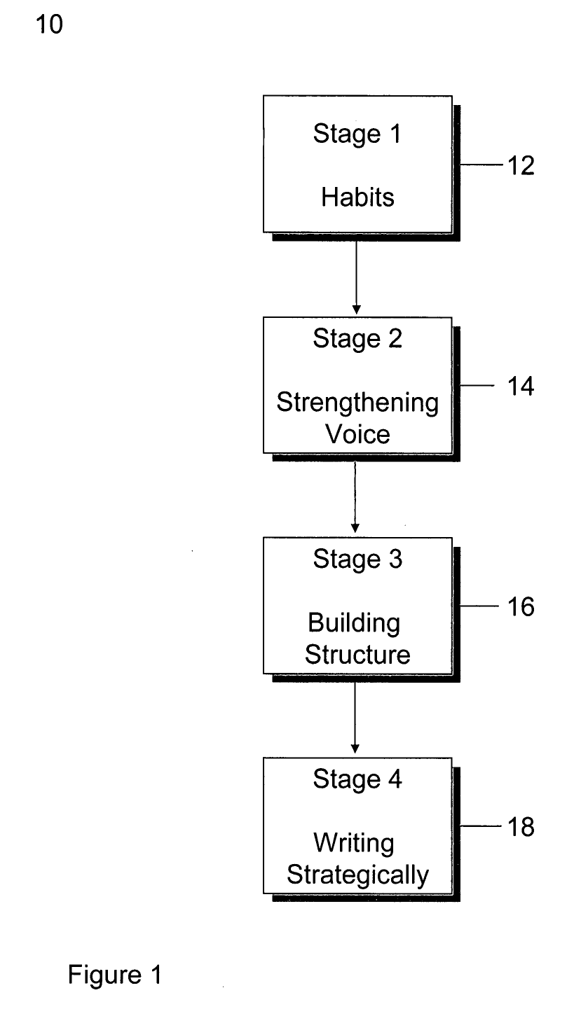

Reference will now be made in detail to the embodiments of the present disclosure that are illustrated in the accompanying figures. Turning now to the figures, attention is directed to FIG. 1. FIG. 1 is a flow chart illustrating a general overview of the method 10 of teaching writing according to the present disclosure. Method 10 focuses on a discrete set of skills that are generally introduced to students in a pre-determined order. This pre-determined order was based on many years of research that resulted in the discrete skill sets according to the present disclosure. At step 12, teachers perform the tasks in stage 1. Stage 1 teaches students foundational habits. Foundational habits or behavioral habits are the core skills practices and attitudes that fuel the development of writing ability. The foundational skills taught in stage 1 include: writing journal entries, practicing skill drills, receiving and using feedback, engaging in experience, sharing writing and developing vocabulary and spelling. During stage 1, students learn to maintain the essential discipline to write effectively, even when faced with challenges. Students learn to work efficiently as an individual and in a group. Stage 1 also teaches students to focus on using writing to develop their own ideas—as opposed to meeting the specific requirements of a teacher or a genre.

Teachers follow the skills of stage 2, strengthening voice, at step 14. Stage 2, strengthening voice, focuses on teaching students to express their own images, feelings and ideas with clear and powerful sentences and paragraphs. During this stage students learn to follow basic grammar conventions habitually, even when excited, bored or confused. Students also learn to focus writing on one moment, object, setting or theme. One moment refers to one specific point in time that a student may select to write about. Additionally, students learn strategies to reveal perspective with vivid descriptions of settings, characters, feelings and ideas.

At step 16, students learn the skills incorporated into stage 3, building structure. During stage 3, students learn to structure sentences and paragraphs to engage a reader. Students will learn to recognize that the order in which sentences first appear is not always the most compelling for an audience. Students will also develop a sophisticated facility with sentence structure in order to make effective transactions between ideas. Additionally, students learn to recognize the structure of stories and personal essays and can structure paragraph for those genres. Generally, building structure begins around grade 5.

Instructors teach the forth stage, writing strategically at step 18. In stage 4, students learn to become purposeful and strategic about presentation of perspective throughout an entire piece. Students also learn to restructure writing to meet conventions of stories, personal essays and persuasive essays. Furthermore, students learn to restructure writing to maintain a reader's engagement throughout a multi-page piece. Typically, stage 4, writing strategically begins at grade 7.

Each new skill throughout all four stages builds upon the previous skill. Once a student learns a skill, that student will never stop working on it so that each skill will evolve through the learning stages. The inventive method addresses a set of prerequisite behavioral habits before addressing a student's writing ability the initial order of which is focus, i.e., a writer's ability to develop a central moment of description, narrative or analysis; and showing, i.e., the use of evidence, and sentence mechanics. The main sets of skills include foundational habits, expressive skills and technical skills. Stage 1 focuses on foundational habits and also begins to teach genre writing. Beginning at stage 2, students will begin to learn expressive and technical skills. Expressive skills are those skills associated with developing an individual's distinctive writing voice and perspective. A student's voice is a student's ability to express his or her own thoughts, feelings, and perceptions in writing. Technical skills are those skills concerning matters of grammar and usage.

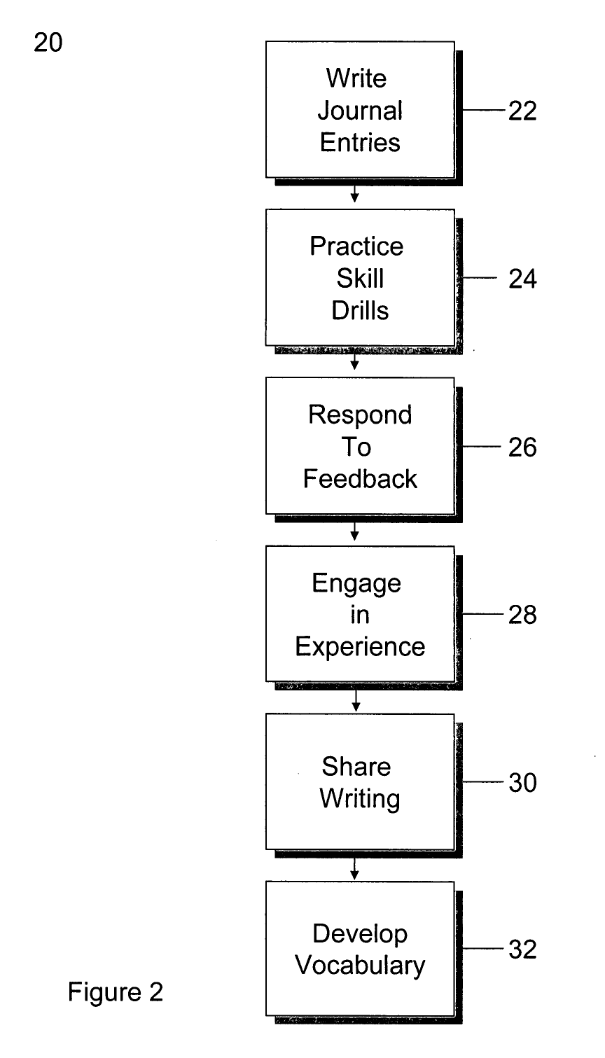

Now referring to FIG. 2, by way of example, the foundational habits included in the method 20 of the skills hierarchy of stage I are illustrated. An instructor may teach the foundational habits in a variety of different orders as may be determined by the instructor. At step 22, instructors teach the first foundational habit, writing journal entries. Writing journal entries is the habit of writing short pieces that focus on particular content and that utilize the skills that a writer has internalized. At step 24, students learn the foundational skill of practicing skills drills. Quick drills teach students by having them complete quick assignments with minimal direction in a timely fashion. Skill drills are short, e.g., 5-15 minute group exercises or lessons that target one expressive or technical skill. The purpose of a skill drill is to introduce a skill, provide opportunity to practice, allow teacher to access students understanding, isolate a particular skill that students can master quickly and integrate into their writing. A revision assignment is a short exercise that a student accomplishes using an excerpt from own writing to practice a skill. The purpose of revision assignments is to provide practice in a skill with writing that the student cares about. The teacher will show the student how the skill is integrated into the student's own writing.

At step 26, students learn the foundational skill of responding to feedback which includes receiving and using feedback. Receiving and using feedback is the habit of looking to see the impact of one's writing on an audience in order to refine skills and particular pieces of writing. Receiving and using feedback incorporates commenting, revision assignments as discussed previously, sharing, posting and conferences. Comments include authentic supportive and targeted statements in response to a particular piece of writing. The purpose is to create a habit of welcoming information from a reader and connecting that information with the student's own writing. Feedback is discussed below in further detail.

Sharing is having the student read the student's work writing out loud and listening to a reader describe the impact of a particular part. The purpose of sharing is to teach the habit of revealing one's own written products to an audience and looking for information and reaction. Posting is selecting a small excerpt from a piece of writing to demonstrate a particular skill or strength and displaying it in the classroom or school. This teaches the habit of identifying a particularly strong element in the student's own writing. Furthermore, conferences are an important part of receiving and using feedback. Conferences are typically a brief, e.g., 30 seconds-2 minutes, one-on-one meeting with a student about a particular pattern or issue in that student's writing.

Students learn the skill of engaging in experience in step 28. Engaging in experience is an important skill because when a student is engaging in experience, that student is making choices and reacting in ways that are particular to that student. Moreover, when a student is engaged, even the most mundane experience provokes unique images, feelings and ideas. Students learn the skill of sharing writing at step 30. Many successful students regularly share writing with teachers and peers, while noticing the impact of that writing on others. The student will practice reading out loud and listening to a reader describe the impact of a particular part. This teaches the habit of revealing written products to an audience and looking for information in their reactions. Additionally, practicing reading out loud is critical to the development of reading skills.

An instructor teaches the skill of developing vocabulary which includes vocabulary and spelling, at step 32. Students need to continually build vocabulary knowledge and practice correct spelling to become and remain successful. The skill of learning vocabulary and spelling requires consistently experimenting with and appropriately integrating new vocabulary into writing to maximize precision and impact of the writing. The purpose of these skills are to create a habit of using a variety of opportunities to learn how to use new words. For example, students learn to use new words in the classroom, with peers, at home and in sports.

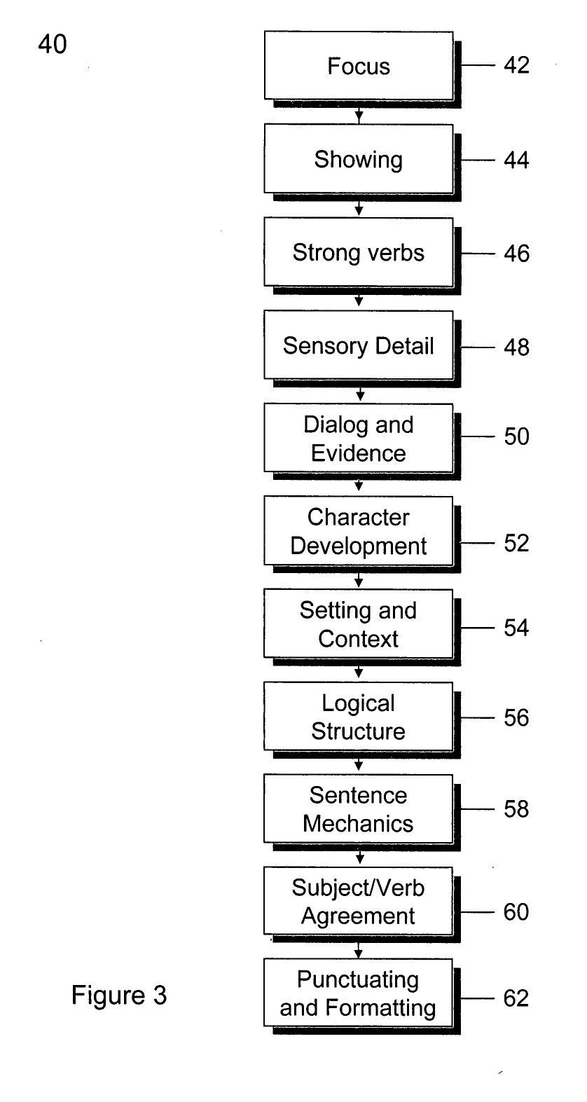

Stage 2, strengthening voice shown as 40, of the skills hierarchy of the method for teaching writing according to the present disclosure is depicted in FIG. 3. Stage 2 begins to introduce both expressive skills and technical skills. The expressive skills that instructors teach in phase 2 include focus, showing, strong verbs, sensory detail, dialogue & evidence 1, character development, setting and context I and logical structure I: distinguishing moments. The technical skills of stage 2 include sentence mechanics and usage 1, subject/verb agreement 1 and punctuating and formatting dialogue and quotations.

The first expressive skill, focus, is taught at step 42. Focus is a writer's ability to stick with and develop one central moment, place, theme or topic. Students need to work on focus when there are certain traits present in a students writing. Some of these traits are the writer just lists events, the writer lacks showing of emotion, the writing is short, the writer rambles or the writing shows much without leading somewhere, the writer jumps from one idea to another, or the writing expresses lack of observations or interest. Students will likely need to work on this skill throughout the entire skills hierarchy. Proficiency for these skills varies at different grade levels, however, an important trait to becoming efficient is that the student is able to dedicate an entire entry to a single moment, object or place.

At step 44, an instructor teaches the second expressive skill which is showing. Showing is a writer's ability to use precise observations, descriptive details and expressive language to communicate emotion, evoke images and present evidence. A writer who is able to show and incorporate descriptive details as opposed to making a general statement is able to engage a reader. Some examples of when students should work on showing when writing lacks specific language, the writer makes general statements about feeling or situations, the writing is very short, the writing rambles, the writer uses may similes, or writer writes in a generalized voice. A student who shows progress in this skill understands the difference between telling and showing, focuses on descriptive detail in place of telling and connects observations to emotions.

An instructor teaches the skill of strong verbs at step 46. Strong verbs are verbs that describe the action and precisely express the emotion, attitude or nature of the actions. As a student becomes proficient in using strong verbs, the student is able to commonly use strong precise verbs and can replace imprecise verbs with strong verbs either when prompted or can identify and independently replace imprecise verbs with strong verbs depending on grade level. The skills of strong verbs also focuses on minimizing the use of the verb “to be.” Students will learn how to recognize the use of the verb “to be” and replace this with stronger verbs.

At step 48, an instructor teaches the still of sensory detail. Sensory detail is a writer's ability to describe details of sight, sound, touch, smell, and/or taste to evoke a vivid image for the reader. Sensory detail is a specific type of showing, as described above, however, sensory detail requires dedicated instruction and practice. Students need to work on sensory detail when the writer, for example, lists or summarizes events, lacks use of specific descriptions or only includes visual detail or too many sensory details. A student who uses sensory detail proficiently can create writing that engages a reader more than just visually, they are able to show physical evidence that supports an opinion, and the student can affect tone and characterization through physical detail.

A student learns the skill of dialogue and evidence I at step 50. Integrating dialogue is a writer's ability to choose dialogue and blend it effectively with narration or analysis to enrich plot or character, or present evidence. Using dialogue includes both technical and expressive elements. Many students under use dialog, or they overuse dialogue and it is not effective. Students need to work on dialogue in many situations. Some of these situations, for example, include when a student's writing lacks character interactions, the writer does not quote evidence, the dialogue lack showing or the writer includes random nonessential dialogue. Students who become proficient in using dialogue can use dialogue to show character and plot development, include questions as evidence, transition smoothly in and out of dialogue and eliminate unnecessary dialog.

An instructor introduces the skill of character development at step 52. Character development is a writer's ability to create complex, 3-dimensional characters by showing how these characters act and react in different situations. Characteristics of students who need to work on developing character can include the writer sums up character with telling statements, the character's actions are predictable, the writer creates a character they have no connections to, the character doesn't interact with the setting or the character is described generally. Students will begin to develop character at approximately grade 3. At grade 3, a student is proficient if they can develop characters that are believable and based on the student's own experience. The student will progress with each grade and by grade 8 should be able to develop characters that are believable and based on the student's own experience, use description to communicate characters' qualities, show some change or growth in character and develop charters that are multi-faceted.

At step 54, an instructor teaches the skill of setting and context I. Developing setting and context is when a writer provides sufficient information about particular events, characters, background or circumstances to establish his intended perspective to the reader. Students who become proficient in the skill of setting and context will be able to use a variety of strategies, e.g., narrative, dialogue or exposition to clearly set the scene or provide a context for the reader. The student becomes aware of the power of words and description to set the tone or create the mood of piece. The student will begin to attempt to minimize the use of clichés, instead looking for unique ways to express a situation. Setting and context I can focus on establishing a sense of place and time, establishing an atmosphere, and using setting and background information purposefully. Setting and context instruction typically begins at grade 5.

At 56, an instructor teaches the skills of logical structure I: distinguishing moments. Logical structure occurs when writers can use structure to enhance a voice and effectively convey a point of view. An instructor teaches students to recount events in a logical and sequential manner. Narrative structure, cause and effect, and effective transitions are important features of logical structure. Students need to work on logical structure when the writer confuses cause and effect or the writer opens with a generic opening. As a student progresses with this skill, they will be able to recount an event in a logical and sequential manner and will eventually be able to understand cause and effect. Additionally, students will be able to write with a clear, unique and engaging beginning, middle and end. Logical structure I focuses primarily on distinguishing and sequencing moments within an event.

Students learn the first technical skill, sentence mechanics and usage 1: the complete sentence at step 58. A complete sentence expresses a complete idea with a subject and a predicate. Writers that do not demonstrate the understanding of capitalization and/or punctuation need to work on this skill. Additionally, students need to work on complete sentences if the writer does not demonstrate an understanding of subjects and predicates or the writing contains fragments or run-on sentences. The progression of this skill varies greatly from grade to grade. Students will begin to learn and begin to define different parts of speech at grade 3 and as they progress up to grade 8, students will focus on sentence structure, punctuation, and specific parts of speech.

At step 60, instructors introduce the skill of subject/verb agreement I. Instructors work with students to first teach students how to identify subject and verb agreement and incorporate this into the student's writing. Consistent subject/verb agreement is a writer's ability to maintain subject/verb agreement while using complex sentence structures or a variety of verb tenses so the reader clearly understands who is doing what. Subject/verb agreement generally begins to be a focus at grade 5 when students begin to match singular or plural subject to the correct verb form. Students will also learn to match verb form with correct tense. Traits that show that a students needs work in this area include plural verbs follow singular nouns and visa versa, verbs do not agree with collective nouns, verbs do not agree with compound subjects joined by “and/or” and writer has difficulty with indefinite pronouns.

An instructor will then focus on teaching punctuating and formatting dialogue and quotations and using these skills to improve writing at step 62. Punctuating and formatting dialogue occurs when writers follow a consistent set of rules about how to present the speech of one or more speakers so the dialogue is clear to the reader. Generally, students focus on this skill in grades 3 though 8. Students should work on punctuating and formatting dialogue when many different traits are exhibited. For example, such traits can include missing quotation marks around dialog, quotations are around to much, end punctuation is misplaced, paragraphs don't change when speaker changes, writer uses “that” to avoid writing dialog, writer doesn't identify quoted thoughts, writer doesn't identify speakers or writer doesn't identify quoted evidence. The technical skills of stage 2 may be combined into one skill, punctuating and formatting dialogue and quotations, as students enter into the later grades, generally grades 7 and up.

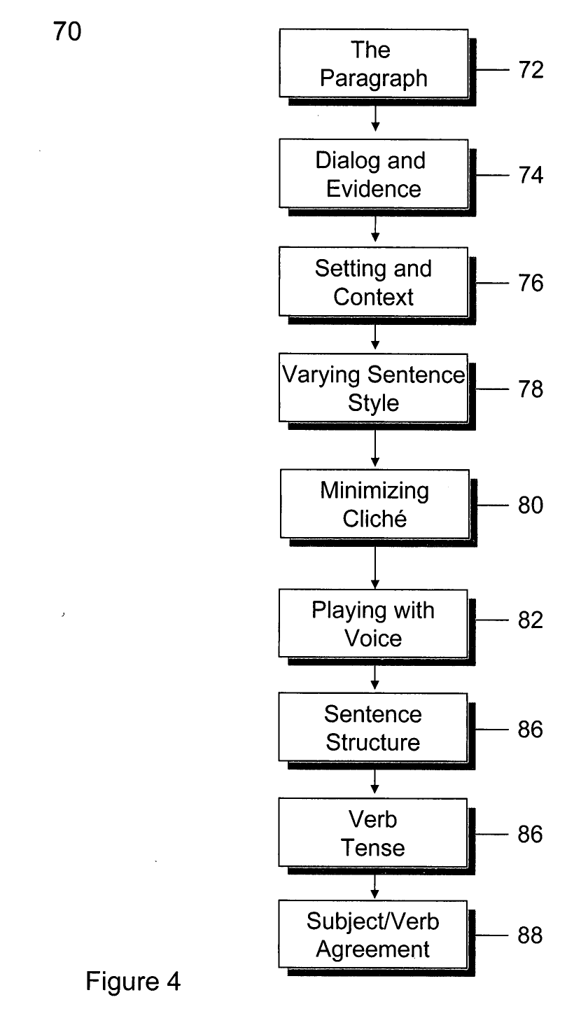

Stage 3, namely building structure, is depicted generally as 70 in FIG. 4. The expressive skills of focus in stage 3 include logical structure II: the paragraph, dialogue and evidence II, setting and context II, varying sentence style, minimizing cliché and playing with voice. The technical skills of focus in stage 3 are sentence mechanics and usage II: sentence structure, verb tense, and subject/verb agreement II. Generally, instructors introduce stage 3, building structure, at grade 5.

An instructor teaches logical structure II: the paragraph, at step 72. Logical structure II: the paragraph is a continuation of logical structure I, distinguishing moments, as discussed above. Logical structure II focuses on paragraph structure, experimenting with sequence, and experimenting with transitions. This builds on the skills learned in logical structure I in phase II.

An instructor teaches dialogue and evidence II at step 74. Dialogue and evidence II focuses on using and developing evidence which is the ability to find and present in writing evidence that is relevant, credible and compelling. As students progress with this skill, students begin to notice and then use relevant and credible evidence and eventually will be able to explicitly link details to theme or argument. Students will also be able to match details to the purpose of the piece.

At step 76, an instructor will teach setting and context II. Setting and context II builds on setting and context I as previously discussed. The skill focuses on establishing an argument, presenting background information, defining the parts of the argument and sequencing the parts of the argument.

Varying sentence style is shown at step 78. Varying sentence style is a writer's ability to use different sentence length and structure to emphasize certain words or phrases, or change the tone of a piece of writing. At approximately grade 4, students become aware of varying sentence structure. Students will work to eventually be able to consistently vary sentence beginning to make writing interesting. The student will begin to write with more complexity and consider varying sentence length, structure and rhythm. Problems that students have that require attention to this skill can include the student starts many sentences the same way, the writer arranges dialogue in the same way and the sentences are all the same length and the same structure. Additionally, students will learn to minimize passive voice. The students will learn to understand the difference between active and passive voice and will structure sentences to communicate ideas most clearly and powerfully.

The skill of minimizing cliché is the focus at step 80. The skill of minimizing cliché is when a writer can recognize stock, stereotypical and overused characters, language, and arguments and, instead express unique perspective in the writer's own words. When a student minimizes clichés, the writing includes more specifics about setting and description and may seem choppy or less coherent at first. Eventually, the student's writing will become more focused with more involved description and dialogue will become more personal. Additionally, the writing become grounded in a specific time or place. Generally, the skill of minimizing cliché is introduced at around grade 7.

At step 82, the skill of paying with voice is introduced. Playing with voice is the writer's ability to experiment with the style, tone or structure of the person's own writing to convey a particular perspective to the reader. As the student progresses with playing with voice the student will be ale to create a scene out of his or her own experience. The student's writing will also show the interest and opinion of the writer.

Instructors address the technical skill of sentence mechanics and usage II, sentence structure, at step 84. Sentence mechanics and usage II builds on the skills learned in sentence mechanics and usage I, as previously discussed. The focus of sentence and mechanics and usage II is compound sentences, complex sentences, correcting fragments, correcting run-on sentences and the correct use of semi-colons, colon and dashes. These skills will vary from grade level and skill level and may need to be partially addressed in stage 2.

At step 86, instructors teach the skill of verb tense. Verb tense is an important skill because verb tense shows when the action happened in time or in relation to another action. As skills progress in this area students will begin to learn using consistent verb tense in a sentence and will grow to be able to change regular verbs between tense and use consistent verb tense in an entire paragraph or piece.

At step 88, instructors focus on subject/verb agreement II, which builds on the skills of subject/verb agreement I as previously discussed. Subject/verb agreement II focuses on singular and plural subjects along with correct form of verb tense as described previously at step 88.

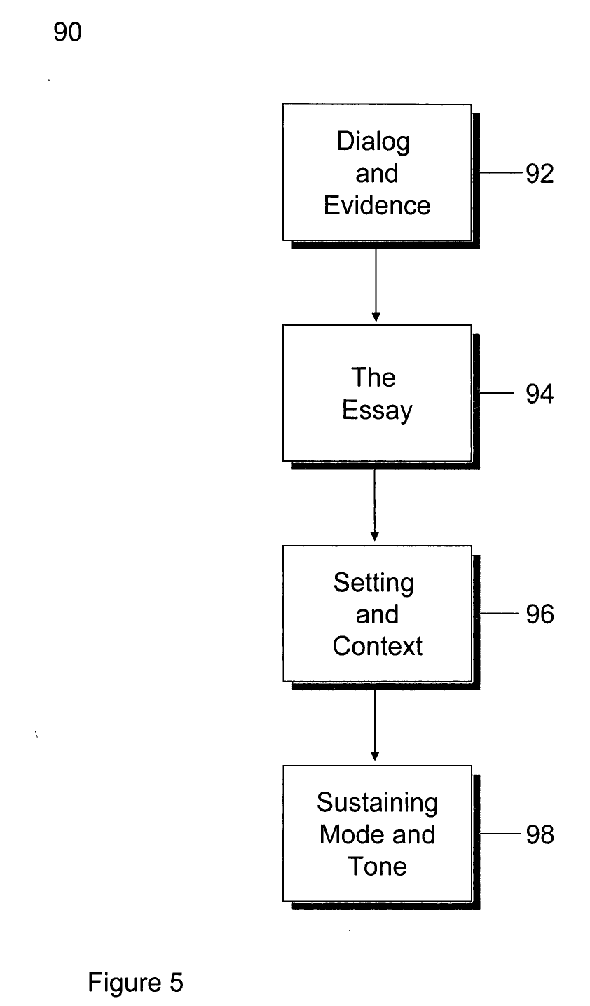

FIG. 5 depicts stage 4, shown as 90 of the method of teaching writing according to the present disclosure. Stage 4 may vary greatly depending on skill level and grade level, however, the primary focus is on writing strategically. At step 92, students again focus on dialogue and evidence. Instructors monitor students' skills of detailed explication and focused analysis. Also in stage 4, logical structure III focuses on the essay at step 94. Students will learn to write polished pieces that are stories, personal or persuasive essays that evolve over the course of several drafts. Setting and context III, at step 96 includes the skills of writing so that implication of argument are clear and the context of the evidence is clear. Instructors can also focus on the skill of mood and tone at step 98. The mood and tone is the emotional feeling inspired by a literary work. Students learn to focus on mood and tone and develop these skills in writing.

Journal writing is used throughout each stage of the method of teaching writing according to the present disclosure. Students regularly write journal entries in order to develop their voices and to internalize skills on which they are working. Journal writing also plays a critical role in instructional feedback.

Instructional pre-determined feedback, comment and conferences are employed throughout each stage of the method of teaching writing according to the present disclosure. Instructional feedback includes appreciative comments and instructive comments. Appreciative comments are comments indicating the impact the student's work has had on the teacher or another reader. Instructive comments are comments that direct the student to correct, improve or practice a specific skill. Instructional feedback is given throughout each stage and for each developing skill. Instructional feedback also provides an avenue to require the student to complete a brief revision that implements the specific writing skill. It may be important to separate in time the step of providing appreciative comments to the student from the step of providing instructive comments to the student so that the student has time to respond and react to the instructive comments.

Each stage of the skills hierarchy incorporates a tracking tool. The tracking tool is an indicia of each student's or students' progress. This tracking tool is located in immediate proximity to the site of the student work and teacher feedback, i.e., inside the student's journal as opposed to in the teacher's grade book. The site of a student's work may be a notebook, journal, tablet or other place where a student can write. The tracking tool makes the student's progress easily accessible to both the student and teacher. The tracking tool also aligns with the skills hierarchy in accordance with the method of the present disclosure so that progress may be tracked throughout the sequence of skills. An instructor can mark and track on the tracking tool as a student becomes proficient in certain skills. The tracking tool may be any variety of card or sticker that is easily accessible to both teach and student. It is also contemplated that the tracking tool is a placemat or sign.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A method of teaching writing comprising the steps of:
instructing a student with a set of writing skills that is organized by skill sets;
the skill sets being taught according to a research-based, predetermined sequence in order to teach writing ability to the student;
the sequence of skill sets addressing a set of prerequisite behavioral habits prior to addressing the students' writing skills; and
the sequence of skill sets including the ability to develop a particular moment description, the ability to use evidence for the moment description, and the ability to use correct sentence mechanics in the moment description.

2. The method of claim 1, wherein the skill sets include establishing habits and strengthening voice to teach students to express their own thoughts, feelings, and perceptions with clear and powerful sentences and paragraphs.

3. The method of claim 2, wherein strengthening voice includes expressive skills and technical skills.

4. The method of claim 1, wherein the skill sets further include building structure to teach students to write sentences and paragraphs to engage a reader.

5. The method of claim 4, wherein building structure includes learning paragraph use and structure, creating dialogue and using evidence, developing setting and context, varying sentence style, varying voice, developing sentence structure, working on verb tense, and learning subject verb agreement.

6. The method of claim 5, wherein the building structure further includes the skill minimizing cliché.

7. The method of claim 1, wherein the skill sets further include the skill of writing strategically.

8. The method of claim 7, wherein writing strategically includes learning to use dialogue and evidence.

9. The method of claim 7, wherein writing strategically includes essay writing, developing setting and context, and sustaining mood and tone.

10. The method of claim 2, wherein the behavioral habits include writing journal entries, practicing skill drills, engaging in experience, responding to feedback, developing vocabulary and sharing writing.

11. The method of claim 1, wherein the skill sets include focus, showing, strong verbs, sensory detail, dialogue and evidence, character development, and distinguishing moments.

12. The method of claim 1, wherein the moment description includes the development of a particular moment narrative or analysis.

13. The method of claim 1, wherein the method includes the step of providing predetermined feedback.

14. A system for teaching writing comprising:
an instructional component indicating a developmental sequence of discrete writing skills;
the instructional component including a tracking tool located in proximity to a location of student work and teacher feedback;
the tracking tool including indicia for the student and teacher to access the student's progress with the developmental sequence of discrete skills; and
the tracking tool providing teacher feedback of the student's developmental sequence of discrete skills so as to enable the teacher to track the student's individual progress with the developmental sequence of discrete skills.

15. The system of claim 14, wherein the sequence of discrete writing skills includes establishing habits and strengthening voice.

16. The system of claim 14,wherein the tracking tool includes a sticker, card, placemat, and sign.

17. The system of claim 14, wherein the tracking tool includes indicia for marking down when a student has accomplished a certain level of proficiency in a discrete skill.

18. The system of claim 14, wherein the tracking tool is located in proximity to a writing tablet, notebook or writing journal.

19. The system of claim 14, wherein the tracking tool provides the teacher with tracking data for focusing the teacher feedback on identified areas of need of the student's developmental sequence of discrete skills.

20. A system of instructional feedback on writing comprising the steps of:
providing appreciative comments from a teacher to a student indicating the impact the student's writing has made on the teacher;
providing instructive comments that direct the student to correct or improve or practice a specific discrete writing skill;
separating in time the step of providing appreciative comments to the student from the step of providing instructive comments to the student; and
requiring the student to complete a revision of the student's writing that implements the specific discrete writing skill.

21. The system of claim 20, wherein the step of providing appreciative comments includes the teacher's response as a reader of the writing or the affect the student's writing had on the teacher.

22. A method for teaching writing skills comprising:
providing a sequence of skills hierarchy for a student's development of a corresponding sequence of writing skills;
instructing the student to perform a first task in said sequence;
providing predetermined feedback to the student which addresses specific deficiencies in the student's performance of the first task;
repeating said instructing and providing until the student has reached a predetermined measurable achievement level in the first task;
for each remaining of tasks in the sequence:
instructing the student to perform a next task in said sequence;
providing predetermined feedback to the student which addresses specific deficiencies in the student's performance of said task;
repeating said instructing and providing until the student has reached a predetermined measurable achievement level in the task before moving on to the next task in the sequence.

23. The method of claim 22 wherein said sequence of learning skills comprises a first stage consisting of establishing foundational habits; and a second stage consisting of strengthening voice.

24. The method of claim 23 further including a third stage consisting of building structure; and a fourth stage consisting of writing strategically.
